(19) United States
(12) Patent Application Publication
(10) Pub. No.: US 2016/0179765 A1
(43) Pub. Date: Jun. 23, 2016

(54) METHOD AND SYSTEM FOR EXTRANEOUS OBJECT NOTIFICATION VIA DIGITAL CONTENT REPAGINATION

(71) Applicant: Kobo Incorporated, Toronto (CA)

(72) Inventors: Benjamin LANDAU, Toronto (CA); Inae HEO, North York (CA)

(73) Assignee: KOBO INCORPORATED, Toronto (CA)

(21) Appl. No.: 14/576,097

(22) Filed: Dec. 18, 2014

(51) Int. Cl. G06F 17/21; G06F 3/0483; G06F 3/0488; G06F 3/041

(52) U.S. Cl. CPC G06F 17/217; G06F 17/214; G06F 3/0412; G06F 3/0418; G06F 3/0483; G06F 3/0488

(57) ABSTRACT

A method and system for notifying an observer of the presence of one or more extraneous objects on a touchscreen display of a mobile computing device, in a manner allowing precise droplet removal. In a mobile computing device having display screen including touch sensors, where the processor is capable of inferring a presence of an extraneous object on the display screen based on an interaction with the touch sensors, the method comprises: determining a spatial area around an interaction in response to an inference that an extraneous object is present on the display screen; rendering a perimeter of the spatial area; identifying an obstructed text portion of displayed e-book content encompassed by the perimeter; and repaginating the displayed page in response to displaying the obstructed text portion outside of the perimeter.

### TECHNICAL FIELD

Examples described herein relate to a system and method for notifying a user of a mobile computing device of an extraneous object present on a touchscreen display thereof.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Koho Aura H2O and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content fur a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

As mobile computing devices having functionality for e-reading proliferate, users find it beneficial to be able to operate such devices in many varied surroundings to continue reading their favorite e-book, such as for example, at the beach, at poolside, and the like.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a mobile computing device for operation with an extraneous object notification interface, according to an embodiment.

FIG. 2 illustrates a schematic configuration of a mobile computing device configured with an extraneous object notification interface for viewing e-book content thereon, according to an embodiment.

FIGS. 3a and 3b illustrate example configurations of an extraneous object notification interface for operating a mobile computing device for viewing e-book content thereon, according to some embodiments.

FIG. 4 illustrates a method of operating a computing device including an extraneous object notification interface for viewing e-book content thereon, according to an embodiment.

### DETAILED DESCRIPTION

Embodiments described herein provide for a computing device that is operable even when water and/or other persistent objects are present on the surface of a display of the computing device. More specifically, the computing device may detect a presence of extraneous objects (e.g., such as water, a water splash, dirt, or debris) on a surface of the display screen, and unobtrusively notify the observer or reader to perform one or more operations to mitigate or overcome the presence of such extraneous objects in order to maintain a functionality for use as intended, and/or to maintain viewability of content displayed on the display screen.

Embodiments described herein provide for a computing device that can detect the presence of water and debris (or other persistent objects) on the surface of a display of the computing device. More specifically, the computing device may determine that the surface of the display is wet based on the detection of a plurality of interactions with touch sensors provided with the display. For example, the computing device may determine that the display surface is wet if multiple interactions (e.g., three or more touch-based contacts) are detected, concurrently, and at least one of the interactions is a persistent interaction (e.g., contact with at least one of the touch sensors is continuously maintained fur a threshold duration). The computing device may respond to water detection, for example, by adjusting one or more device settings, for example, a display state, device configurations and notifications and/or input responses.

“E-books” are a form of electronic publication content stored in digital format in a non-transitory computer-readable medium, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books via a pre-determined series of digitally constructed pages, which can be rendered on a display screen of a computing device in a manner intended to mimic a paginated printed publication. Still further, some devices (sometimes referred to as “e-readers”) display digitally-stored content in a more reading-centric manner, while also providing, via a user input interface, the ability to manipulate that content for viewing in discrete successive pages corresponding to the pre-determined order of pages in a physical paper book as published.

An “e-reading device”, also referred to herein as an electronic personal display, can refer to any computing device that can display or otherwise render an e-book. By way of example, e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra=mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

### System and Hardware Description

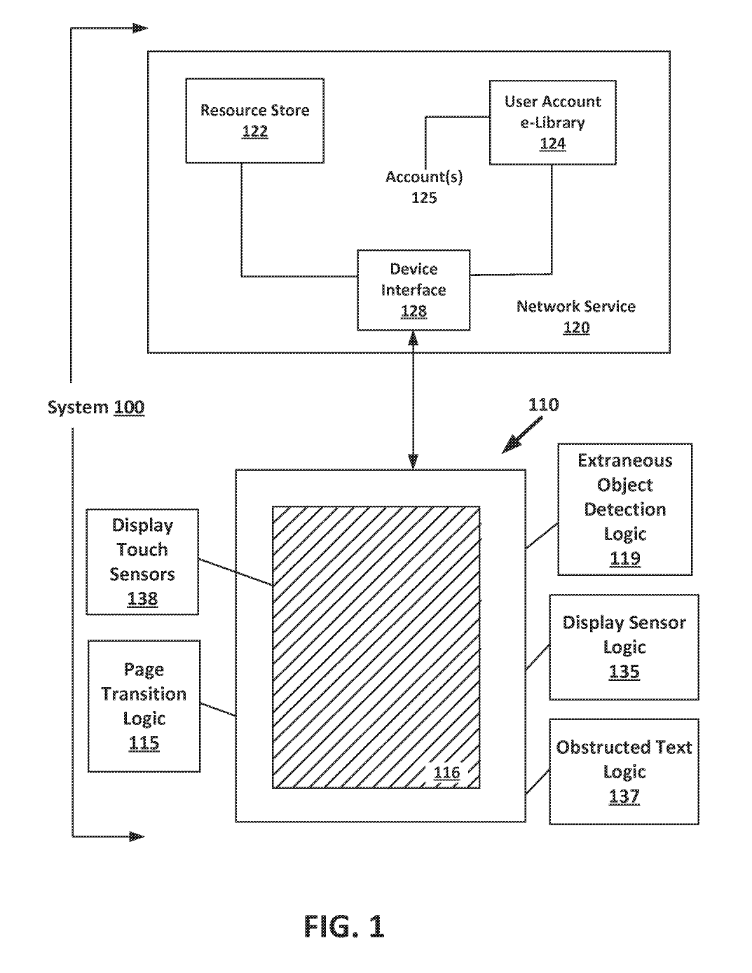

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services in communication with e-reading device 110. The e-book services provided through network service 120 can, for example, include services in which e-books are sold, shared, downloaded or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered for consumption. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an e-ink display.

In additional detail, the network service 120 can include a device interface 128, a resource store 122 and a user e-library 124. User e-library 124 can associate e-reading device 110 with a user and with account 125. Account 125 can also be associated with one or more application resources (e.g., e-books), which can be stored in the resource store 122, comprising an electronic library (e-library) of stored digital content. The device interface 128 can handle requests from the e-reading device 110, and further interface the requests of the device with services and functionality of the network service 120. The device interface 128 can utilize information provided with user account 125 in order to enable services, such as purchasing downloads of content or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, user e-library 124 can retain metadata for individual accounts 125 to identify resources or content that have been purchased or made available for consumption for a given account. The e-reading device 110 may be associated with the user account 125, and multiple devices may be associated with the same account. As described in greater detail below, the e-reading device 110 can store digital content items (e.g., e-books) that are purchased or otherwise made available to the user of the e-reading device 110, as well as to archive e-books and other digital content items that have been purchased for the user account 125, but are not stored on a particular computing device.

With reference to an example of FIG. 1, e-reading device 110 can include a display 116. In an embodiment, display 116 is touch-sensitive, to process touch inputs including gestures (e.g., swipes). For example, the display 116 may be integrated with one or more touch sensors 130 to provide a touch-sensing region on a surface of the display 116. For some embodiments, the one or more touch sensors 130 may include capacitive sensors that can sense or detect a human body's capacitance as input. In the example of FIG. 1, the touch-sensing region coincides with a substantial surface area, if not all, of the display 116. Yet further, an interaction received at the touch-sensing display 116 may coincide with the specific location of touch-sensors 130 involved thereon.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display 116. For example, the user may swipe the surface of the display 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display 116.

According to some embodiments, the e-reading device 110 includes display sensor logic 135 to detect and interpret user input or user input commands made through interaction with the touch sensors 130. By way of example, the display sensor logic 135 can detect a user making contact with the touch-sensing region of the display 116. More specifically, the display sensor logic 135 can detect taps, an initial tap held in sustained contact or proximity with display 116 (otherwise known as a “long press”), multiple taps, and/or swiping gesture actions made through user interaction with the touch sensing region of the display 116. Furthermore, the display sensor logic 135 can interpret such interactions in a variety of ways. For example, each interaction may be interpreted as a particular type of user input corresponding with a change in state of the display 116.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116.

E-reading device 110 further includes extraneous object detection (EOD) logic 119, which in conjunction with display sensor logic 135, may operate to for detect the presence of water (and/or other extraneous objects) on the surface of the display 116. More specifically, the EOD logic 119 may determine that water is present on the surface of the display 116 based on detected interactions with the touch sensors 130. EOD logic 119 may determine that water is present on the display 116 based on a number of touch-based interactions detected via particular ones of touch sensors 130 and/or a contact duration (e.g., a length of time for which contact is maintained with a corresponding touch sensor 138) associated with each interaction. In variations, EOD logic 119 can detect other forms of extraneous objects such as dirt and debris.

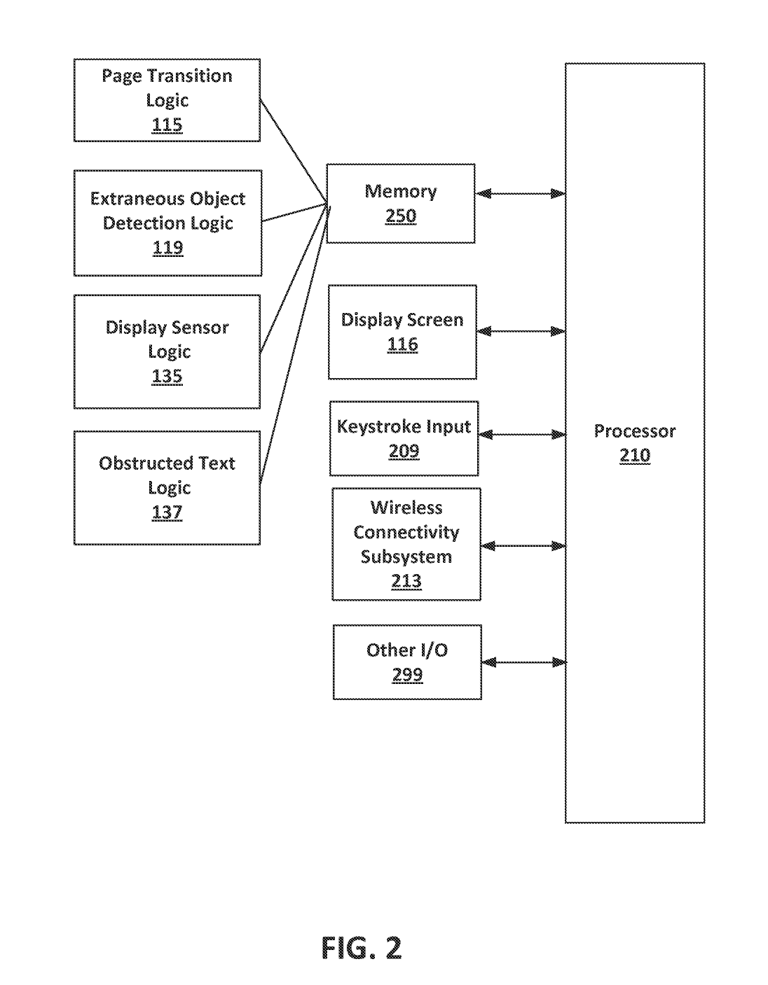

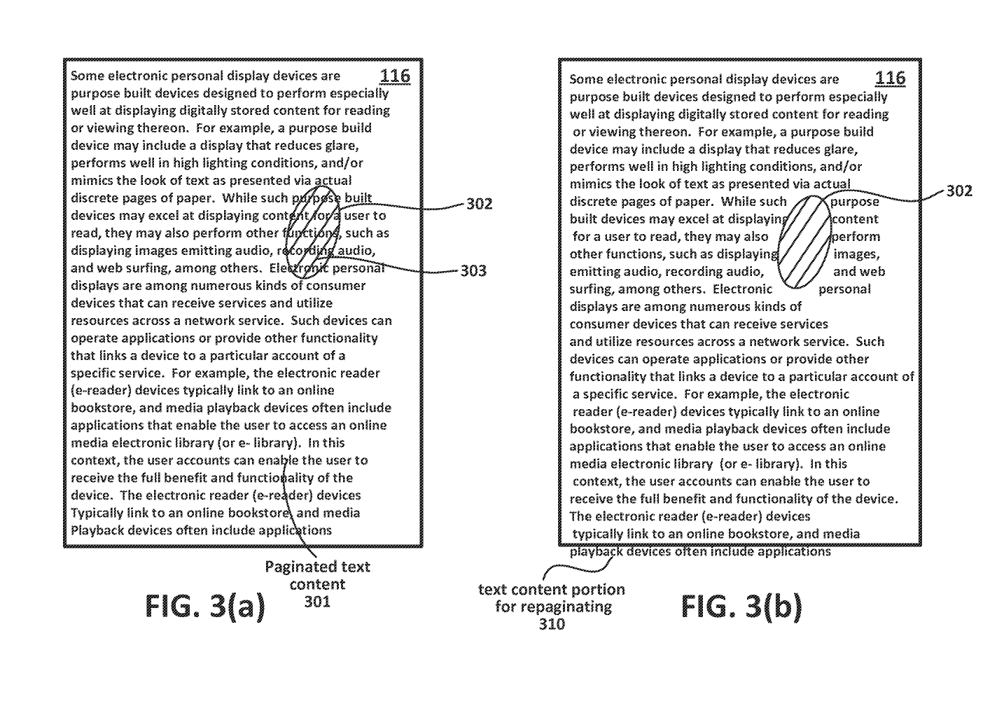

For some embodiments, e-reading device 110 further includes obstructed text logic 137 for appropriately notifying the observer at e-reading device 110 in response to detecting the presence of water and/or other extraneous objects that may obscure content, such as text content an e-book page, being rendered for e-reading on display 116. For example, obstructed text logic 137 may be deployed for re-configuring or re-paginating the e-book page to display appropriate notification when water and/or other extraneous objects are present (e.g., “splashed”) on the surface of the display 116, as will be described further with reference to FIGS. 2 and 3. The term re-pagination as used herein is intended to encompass rearranging content, including text content, of the digital content pages of an e-book while maintaining relative arrangements in the sequence of words and sentences to preserve readability across digitally structured and re-structured pages of the e-book. For example, such as by displacing text words or partial words within the content page while maintaining text attributes (e.g., font type, size and word and line spacing) for continuity in the e-reading experience. Accordingly, obstructed text logic 137 may be activated by the display sensor logic 135 upon detecting the presence of extraneous objects on the surface of the display 116.

One or more embodiments of obstructed text logic 137 and EOD logic 119 as described herein may be implemented by e-reading device 110 using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments of obstructed text logic 137 and EOD logic 119 as described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, flash or solid state memory (such as carried on many cell phones and consumer electronic devices) and magnetic memory. Computers, terminals, network enabled devices (e.g., mobile devices such as cell phones) all examples of machines and devices that utilize processors, memory, and instructions stored on computer-readable mediums. Additionally, embodiments may be implemented in the form of computer programs, or a computer usable carrier medium capable of carrying such a program.

FIG. 2 illustrates a schematic architecture, in one embodiment, of e-reading device 110 as described above with respect to FIG. 1. With reference to FIG. 2, e-reading device 110 further includes a processor 210, a memory 250 storing instructions and logic pertaining at least to display sensor logic 135, extraneous object detection (EOD) logic 119 and obstructed text logic 137.

Processor 210 can implement functionality using the logic and instructions stored in memory 250. Additionally, in some implementations, processor 210 communicates with the network service 120 (see FIG. 1). More specifically, e-reading device 110 can access the network service 120 to receive various kinds of resources (e.g., digital content items such as e-books, configuration files, account information), as well as to provide information (e.g., user account information, service requests etc.). For example, e-reading device 110 can receive application resources, such as e-hooks or media files, that the user elects to purchase or otherwise download via the network service 120. The application resources that are downloaded onto e-reading device 110 can be stored in memory 250.

In some implementations, display 116 can correspond to, for example, a liquid crystal display (LCD) or light emitting diode (LED) display that illuminates in order to provide content generated from processor 210. In sonic implementations, display 116 can be touch-sensitive. For example, in some embodiments, one or more of touch sensor components 138 may be integrated with display 116. In other embodiments, touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display 116, keystroke input 209 such as from a virtual or rendered keyboard, and other input mechanisms 299 (e.g., buttons, mouse, microphone, etc.). With reference to examples described herein, processor 210 can respond to input detected at touch sensor components 138. In some embodiments, processor 210 responds to inputs from touch sensor components 138 in order to facilitate or enhance e-book activities such as generating e-book content on display 116, performing page transitions of the displayed e-book content, powering off e-reading device 110 and/or display 116, activating a screen saver, launching or closing an application, and/or otherwise altering a state of display 116.

In some embodiments, memory 250 may store display sensor logic 135 that monitors for user interactions detected through touch sensor components 138, and further processes the user interactions as a particular input or type of input. In an alternative embodiment, display sensor logic 135 may be integrated with touch sensor components 138. For example, touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which e-reading device 110 is intended to operate, such as in accordance with Wi-Fi, Bluetooth, Near Field Communication (NFC) communication protocols, and the like.

Still with reference to FIG. 2 and the examples described herein, in a particular embodiment, display sensor logic 135 may interpret simultaneous contact with multiple touch sensors 130 as a type of non-user input. For example, the multi-sensor contact may be provided, in part, by water droplets or splashes and/or other unwanted or extraneous objects (e.g., dirt, debris, etc.) interacting with the touch sensors 130. Processor 210 of e-reading device 110 may then infer, that, based on the multi-sensor contact, that at least a portion of the multi-sensor contact is attributable to presence of water droplets, splashes and/or other extraneous objects on the surface of the display 116.

For some embodiments, the display sensor logic 135 may detect the presence of water and/or other extraneous objects, including debris and dirt, on the surface of the display 116. For example, the display sensor logic 135 may determine that extraneous objects are present on the surface of the display 116 based on a number of touch-based interactions detected via the touch sensors 130 and/or a contact duration (e.g., a length of time for which contact is maintained with a corresponding touch sensor 130) associated with each interaction. More specifically, the display sensor logic 135 may detect the presence of water and/or other extraneous objects if a detected interaction falls outside a set of known gestures (e.g., gestures that are recognized by the e-reading device 110).

Obstructed text logic 137 for appropriately notifying the observer at e-reading device 110 in response to detecting the presence of water and/or other extraneous objects that may obscure content, such as text content in an e-book page being rendered for e-reading on display 116. In an embodiment, obstructed text logic 137 may determine a spatial area of an extraneous object overlaying text of an e-book page content being displayed, identify the text, words or partial words of the content that are being obstructed for viewing or e-reading by the extraneous object, then re-paginate the page of content by displacing the identified words or text within the content page to enable unobstructed reading, all the while maintaining the relative arrangements of words and sentences within the content.

With reference now to FIG. 3a, a droplet of water may be detected as present on the display 116, the interaction coinciding with one or more touch sensors 130 of touchscreen display 116 and representing a single continuous object having a spatial area. Obstructed text logic 137 may determine a boundedness of the extraneous object such as by perimeter 302 overlaying and obscuring displayed text content portion 303 within the e-book page content 301. In an embodiment, perimeter 302 may be rendered to coincide with the spatial area of a water droplet. In another embodiment, the perimeter may be rendered as surrounding the spatial area of the interaction, e.g., of the water droplet, to cater for more clearance around underlying obscured text or words of the e-book page content being displayed. The text content may comprise alphanumeric and/or symbol characters having text attributes such as a particular font size or a font type (italics, boldface, etc.). In the particular example depicted in FIG. 3a, displayed text content portion 303 includes words or partial words that are obscured underneath perimeter 302 include text of the words “purpose”, “content”, “for”, “functions”, “recording” and “electronic”.

With reference now to FIG. 3b, illustrated is an embodiment where the words of displayed text content portion 303 having (at least partially) obscured text characters are displaced in order to allow unobstructed readability at touchscreen display 116 of e-reading device 110. To ensure continuity in the e-reading experience, those words are displaced from underneath perimeter 302 to the end of the line position in which they originally appeared within text content 301 (for example, the words “purpose” and “content”, or in the case where a line-wrap operation is necessitated within the digitally structured page displayed on display 116, displaced to a next line of the re-paginated text content 301 (for example, the words “recording” and electronic”). Text content portion 310, comprising the single sentence “playback devices often include applications” exceeds parameters of the original digitally constructed page of text content 301 on display 116. Thus, text content portion 310 is re-paginated onto a next page in the sequence of pages comprising the e-book content, whereby that next page is digitally re-constructed to include text content portion 310 in a first line thereof. For continuity of the reading experience, text attributes of text content portion 310, such as font type, font size, and word spacing, etc., may be maintained.

In another notification aspect, the rendering perimeter 302 may be rendered visually differently to contrast with other content of the e-book page being shown on display 116. It is contemplated that perimeter 302 may be rendered according to different colors and/or different illumination levels, or even via pulsating representation or other visual aspects, in distinction within the larger text content page shown on display 116.

### Methodology

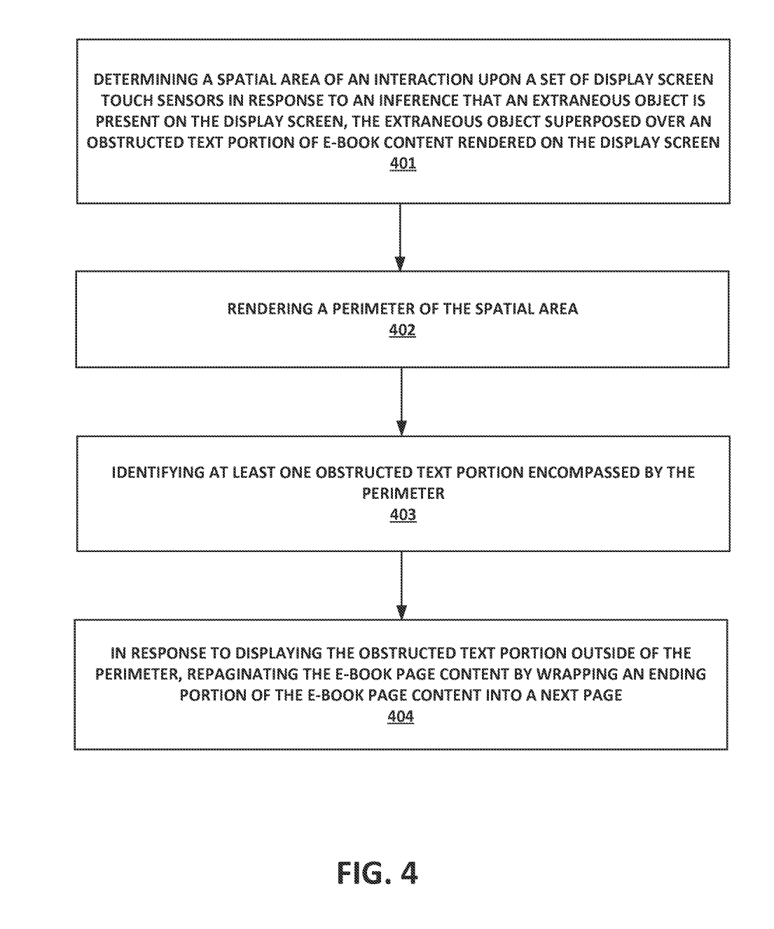

FIG. 4 illustrates a method of operating an e-reading device 110 to provide a notification by way of displacing text word content within a page of e-book content being displayed when water and/or other extraneous objects are present on the display 116, according to one or more embodiments. In describing the examples of FIG. 4, reference may be made to components such as described with FIGS. 1, 2 and 3a and 3b, for purposes of illustrating suitable components and logic modules for performing a step or sub-step being described.

With reference to the example of FIGS. 3a and 3b, the e-reading device 110 may detect the presence of one or more extraneous objects on a surface of the display 116. For some embodiments, display sensor logic 135 may detect the presence of extraneous objects on the surface of touchscreen display 116 based on a number of touch-based interactions detected via the touch sensors 130 and/or a contact duration associated with each of the interactions. For example, the display sensor logic 135 may determine that extraneous objects are present on the surface of the display 116 if a detected interaction falls outside a set of known gestures and threshold time durations associated therewith.

At step 401, determining a spatial area of the interaction in response to an inference that an extraneous object is present on the display 116, the extraneous object superposed over an obstructed text portion of e-book content 301 rendered on the display 116 at the e-reading device 110.

At step 402, rendering a perimeter 302 of the spatial area, the perimeter being superposed over the obstructed text of e-book content shown on the display 116 at e-reading device 110.

At step 403, identifying words of the obstructed text portion encompassed by the perimeter 302.

At step 404, in response to displaying the words of the obstructed text portion outside of perimeter 302, repaginating the e-book page content 301 by wrapping an ending text content portion 310 of the e-book page content into a next page of the e-book content.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method executed in a processor of a computing device, the computing device including a memory storing instructions, a display screen including a set of touch sensors, the processor capable of inferring a presence of an extraneous object on the display screen based on an interaction with the set of touch sensors, the method comprising:
determining a spatial area of the interaction in response to an inference that an extraneous object is present on the display screen, the extraneous object superposed over an obstructed text portion in an e-book content page rendered on the display screen;
rendering a perimeter of the spatial area;
identifying the obstructed text portion encompassed by the perimeter; and
in response to displaying the obstructed text portion outside of the perimeter, repaginating the e-book page content by wrapping an ending text portion of the e-book content page into a next page of the e-book content.

2. The method of claim 1 wherein the extraneous object is one of a water splash and a water droplet.

3. The method of claim 1 wherein the obstructed text portion is identified as comprising at least a partial word.

4. The method of claim 3 wherein the at least a partial word is displaced to an end of line position when displayed outside the perimeter.

5. The method of claim 3 wherein the at least a partial word is displaced into a next line when displayed outside the perimeter.

6. The method of claim 1 wherein the perimeter is rendered according to different illumination level within the e-book content page.

7. The method of claim 1 wherein the perimeter is rendered surrounding the spatial area o interaction.

8. The method of claim 1 wherein the ending text portion of the e-book content page maintains at least one of: a font type, a font size and a word spacing when wrapped into the next page of the e-book content.

9. The method of claim 1 wherein the perimeter is rendered in a color different from content of the e-book page.

10. The method of claim 1 wherein the perimeter is rendered according to a pulsating representation.

11. A computing device comprising:
a memory storing instructions;
a display screen including a set of touch sensors;
a processor capable of inferring a presence of an extraneous object on the display screen based on an interaction with the set of touch sensors, the processor operable in conjunction with the instructions to:
determine a spatial area of the interaction in response to an inference that an extraneous object is present on the display screen, the extraneous object superposed over an obstructed text portion in an e-book content page rendered on the display screen;
render a perimeter of the spatial area;
identify the obstructed text portion encompassed by the perimeter; and
in response to displaying the obstructed text portion outside of the perimeter, repaginate the e-book page content by wrapping an ending text portion of the e-book content page into a next page of the e-book content.

12. The computing device of claim 11 wherein the extraneous object is one of a water splash and a water droplet.

13. The computing device of claim 11 wherein the obstructed text portion is identified as comprising at least a partial word.

14. The computing device of claim 13 wherein the at least a partial word is displaced to an end of line position when displayed outside the perimeter.

15. The computing device of claim 13 wherein the at least a partial word is displaced into a next line when displayed outside the perimeter.

16. The computing device of claim 11 wherein the perimeter is rendered according to different illumination level within the e-book content page.

17. The computing device of claim 11 wherein the perimeter is rendered surrounding the spatial area of the interaction.

18. The computing device of claim 11 wherein the ending text portion of the e-book content page maintains at least one of: a font type, a font size and a word spacing when wrapped into the next page of the e-book content.

19. The computing device of claim 11 wherein the perimeter is rendered in a color different from content of the e-book page.

20. A non-transitory computer-readable medium storing instructions that, when executed by a processor of a computing device, cause the processor to perform operations that include:
determining a spatial area of an interaction in response to an inference that an extraneous object is present on a display screen of the computing device, the extraneous object superposed over an obstructed text portion in an e-book content page rendered on the display screen;
rendering a perimeter of the spatial area;
identifying the obstructed text portion encompassed by the perimeter; and
in response to displaying the obstructed text portion outside of the perimeter, repaginating the e-book page content by wrapping an ending text portion of the e-book content page into a next page of the e-book content.
